(19) United States
(12) Patent Application Publication
(10) Pub. No.: US 2005/0028411 A1
(43) Pub. Date: Feb. 10, 2005

(54) Promotional item having fluorescing or phosphorescing ink indicia

(76) Inventor: Sun Yu, Berkley, MI (US)

Correspondence Address: GIFFORD, KRASS, GROH, SPRINKLE;ANDERSON & CITKOWSKI, PC, 280 N OLD WOODARD AVE, SUITE 400, BIRMINGHAM, MI, 48009, US

(21) Appl. No.: 10/833,570

(22) Filed: Apr. 28, 2004

Related U.S. Application Data
(60) Provisional application No. 60/465,978, filed on Apr. 28, 2003.

(51) Int. Cl. G09F 13/00

(52) U.S. Cl. 40/422; 40/334

(57) ABSTRACT

A promotional item has a housing incorporating an electrical circuit made up of an LED and a battery. The housing is printed with ink forming indicia. The ink fluoresces or phosphoresces to emit visible light under illumination from the light emitting diode.

### RELATED APPLICATION

This application claims priority of U.S. Provisional Patent Application Ser. No. 60/465,978 filed Apr. 28, 2003, which is incorporated herein by reference.

### FIELD OF THE INVENTION

The present invention generally relates to promotional items and in particular to promotional items having fluorescing or phosphorescing ink indicia that become readable upon illumination by a light source located within the item.

### BACKGROUND OF THE INVENTION

The free distribution of promotional items to a target group is a common feature of marketing campaigns. Common promotional items include pens, watches, key chains, flashlights, penlights, alarm clocks, pocket calculators, picture frames, swizzle sticks, magnifying glasses, and side view mirrors. Such promotional items are otherwise conventional items that have been customized to include printed indicia related to the object of the marketing campaign, the objects including a political candidate, a product, a brand, commemorative event, or personal sentiment. A marketer derives value from producing and distributing such promotional items in that the recipient in deriving benefit from the utilitarian functions of the promotional item is at the same time reintroduced to the branding printed indicia. However, promotional materials only partially serve intended marketing purposes owing to the stigma a recipient may associate with the promotional target or a recipient's concern about the perception of others with respect to the marketing target. As a result, a promotional item is often relegated to use in a specific environment or placed into storage, thereby lessening the promotional impact of the item. Alternatively, a promotional item in constant use by a recipient tends to induce a saturation effect such that the recipient no longer is cognizant of the branding printed indicia even being present on the promotional item. Thus, there exists a need for a promotional item having printed indicia thereon formed in invisible ink that becomes intensely visible upon activating a light source suitable for stimulating the invisible ink, the light source activation occurring through the utilitarian activation of the promotional item.

### BRIEF DESCRIPTION OF THE DRAWINGS

FIG. 1 is a schematic of an inventive promotional item;

FIG. 2 is a partial cutaway view of an inventive promotional device configured as a pen;

FIG. 3 is an exploded, partial cross-sectional view of the inventive device depicted in FIG. 1; and

FIG. 4 is a partial cutaway view of an inventive promotional item configured as a wristwatch.

### SUMMARY OF THE INVENTION

A promotional item includes a housing having printed thereon ink forming indicia. The ink emits visible light through fluorescence or phosphorescence upon illumination by a wavelength greater than 365 nanometers and less than 420 nanometers. A light emitting diode within the housing is in optical communication with the ink and is characterized by having an emission wavelength of between 365 nanometers and 420 nanometers. A battery within the housing forms an electrical circuit with the light emitting diode to create an emissive wavelength that in turn stimulates visible light emission from the ink. In instances where the ink is an invisible ink absent emission from the light emitting diode, the ink is essentially indiscernible to the unaided eye.

### DESCRIPTION OF THE PREFERRED EMBODIMENTS

The present invention has utility as a high perceptive impact promotional item. An inventive promotional item includes those items given away, sold, or bartered to enhance the recognition or perception of a design, brand, or other subject embodied in the printed indicia. An inventive promotional item includes printed indicia formed in an emissively stimulatable ink. The ink printed indicia fluorescing or phosphorescing upon activation of a light emitting diode (LED) contained within the inventive promotional item and having an emissive wavelength sufficient to induce stimulated emission in the ink. While the present invention is disclosed with respect to particular promotional item embodiments of a pen and a watch, it is appreciated that the inventive concept of ink that becomes discernable upon illumination by an LED within the promotional item. These illustratively include a pen, watch, key chain, flashlight, penlight, alarm clock, pocket calculator, picture frame, swizzle stick, magnifying glass, or a vehicle side view mirror. The common feature of inventive embodiments being stimulated emission from an ink displayed on the item by way of an LED housed within the item.

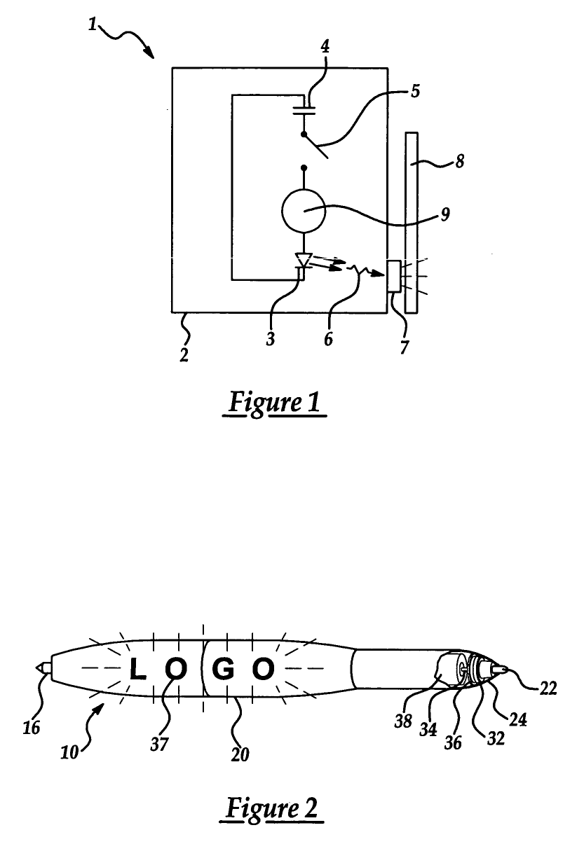

Referring now to FIG. 1, a simplified schematic of an inventive promotional item is shown generally at 1. A housing 2 contains an LED 3 that is energized by the formation of an electrical circuit with a battery 4 upon the closure of a switch 5. Emission 6 from the LED 3 is communicated to an ink 7 that is stimulated by the emission 6 through a fluorescence or phosphorescence process to itself light. While the emission 6 from the LED 3 is in the wavelength range between 365 nanometers and 420 nanometers, light produced by the ink 7 is in the visible portion of the light spectrum. The emission 6 is communicated to the ink 7 by way of a transparent or translucent portion of the housing 2, an optical fiber, or a transparent or translucent sheath 8 overlying the ink 7. Preferably, the LED circuit includes an integrated circuit 9 serving at least one function of: modifying battery voltage input to the LED 3, time limiting the circuit activation, and pulsing the emission 6 from the LED 3.

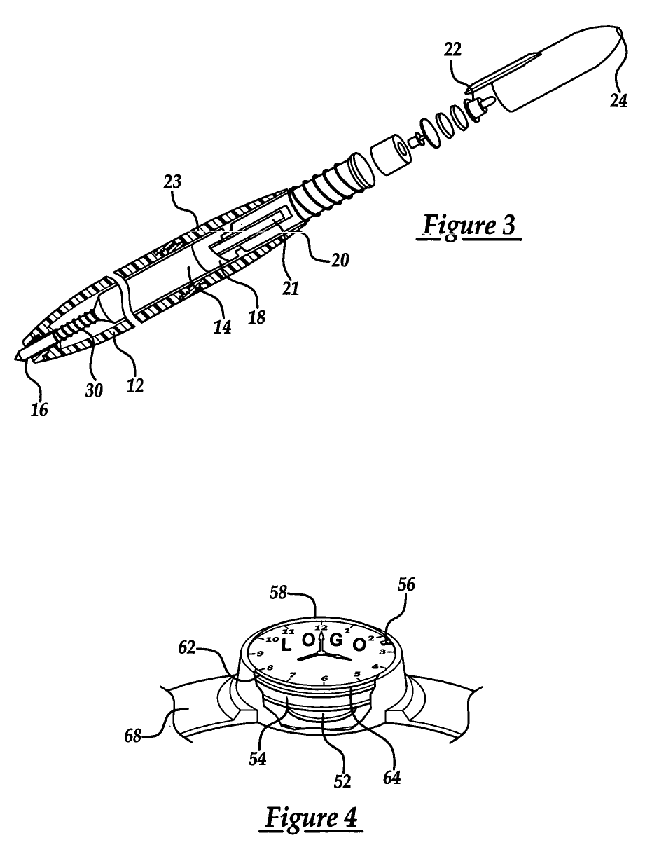

Referring now to FIGS. 2 and 3, an inventive pen is disclosed generally at 10. The pen 10 has a bore 12 containing an ink reservoir tube 14 that terminates in a writing point 16. A reservoir cap 18 frictionally engages the top of the tube 14 within a housing 20. A ridge 21 within the housing 20 selectively engages a recess 23 within the reservoir cap 18 to extend the writing tip 16 from the housing 20. A button 22 is located in the terminus 24 of the housing 20. The ink reservoir 14 and terminal point are then moved between a retracted position and an extended writing position. A lower spring 30 facilitates retraction of the pen point 16. While this conventional set of workings for a pen is detailed as an operative embodiment of the present invention, it is appreciated that the following LED and invisible light components are readily incorporated into any conventional pen configuration.

The button 22 upon depression closes an electrical circuit between a battery 32 and a light emitting diode 34. Preferably, electronic circuitry 36 is part of the electrical circuit and has the function to limit the emission time of the LED 34 to a preselected amount of time. The housing 20 has an optically transparent or translucent sheath 38 thereon. The sheath 38 preferably formed of a polymeric plastic material that is in optical communication with the emissions from the LED 34. It is appreciated that the housing 20 is readily formed as a unitary injection molded and optically transparent or translucent component. Printed indicia 37 are added to the pen 10 in a region visible on the exterior thereof and receiving optical emission from the LED 34. The printed indicia are formed in ink which is defined herein to include a dye or pigment that emits light in the visible portion of the light spectrum upon stimulation by an equal or shorter wavelength. Preferably the dye or pigment has minimal visibility under ambient visible light and is commonly known as an invisible ink. Optionally, a transparent protective overcoat protects ink printed indicia from abrasion (not shown). In order to stimulate an invisible ink to fluoresce or phosphoresce, preferably the LED 34 has an emission wavelength of between 365 nanometers and 420 nanometers. More preferably, the LED 34 has an emission wavelength between 365 nanometers and 405 nanometers. The battery 32 is chosen to have a voltage sufficient to power the LED 34 within a single cell, or as multiple cells in series. Alternatively, the electronic circuitry 36 includes circuitry that serves to step up the battery voltage and deliver a higher voltage alternating current with which to drive the LED 34, such as that disclosed in U.S. Pat. No. 6,366,028 which is incorporated herein by reference.

It is appreciated that the barrel 18 is readily constructed either from a transparent or translucent material, or having a transparent or translucent sheath (not shown) such that portions of the housing 20 and the barrel 18 are in optical communication with the LED 34 such that invisible ink indicia are readily illuminated in both the barrel and housing portions of the inventive pen 10.

In a pen lacking a spring-biased ink reservoir that moves between extended and retracted positions, it is appreciated that LED illumination is readily triggered by removal of a pen cap, the removal of the cap activating a pressure switch mounted on the exterior surface of the pen and preferably within the half of the pen proximal to the writing tip. The activation of the LED as with the embodiments depicted in FIGS. 1 and 2 causes LED illumination for a preselected period of time. Limiting the time of LED illumination serves not only to extend battery lifetime, but also to avoid user saturation to the invisible ink indicia that becomes visible upon illumination.

Referring now to FIG. 4, a watch embodiment is shown generally at 50. The watch 50 is characterized by being powered by a button-type battery 52 that serves to drive an electromechanical watch mechanism 54. A micro light emitting diode is tied to the electrical circuit between the battery and the electromechanical watch mechanism to provide an illumination power source for the LED 56. The LED 56 being located in the watch housing wall 58. Invisible ink printed indicia 60 are present on the crystal 62 and/or face 64 of the watch 50. Preferably, the watch 50 includes a user-operated switch 66 that serves to illuminate a liquid crystal watch face display or a mechanical watch face display. Preferably, the LED 56 emits a wavelength of between 365 nanometers and 420 nanometers. A conventional watchband 68 is secured to the watch housing wall 66 in order to secure the watch 50 to a user.

As part of the electrical circuit that activates LED 56, electronic circuitry limits the duration of LED activation to extend the operating lifetime of the watch 50 and to minimize user saturation to the invisible ink indicia.

It is appreciated that an electronic circuit as described herein for selectively activating an LED emitting a wavelength of between 365 and 420 nanometers is readily incorporated into a key chain, flashlight, penlight, alarm clock, pocket calculator, picture frame, swizzle stick, magnifying glass, or a vehicle side view mirror by one skilled in the art such that emission therefrom falls into a stimulatable ink patterned onto the item. The LED emission transmitted to the ink by way of a transmissive ink substrate and/or an overlying transmissive sleeve.

Although the present invention has been described in terms of specific embodiments, it will be appreciated that various modifications and alterations can be made by one skilled in the art without departing from the spirit and scope of the invention as set forth in the appended claims.

1. A promotional item comprising:
a housing;
an ink forming indicia on said housing, said ink emitting visible light upon illumination by a wavelength greater than 365 nanometers and less than 420 nanometers;
a light emitting diode within said housing in optical communication with said ink and having an emission wavelength capable of stimulating emission from said ink; and
a battery within said housing that forms an electrical circuit with said light emitting diode.

2. The item of claim 1 further comprising an abrasion protective overlayer on said ink.

3. The item of claim 1 wherein said housing is selected from the group consisting of: pens, watches, key chains, flashlights, penlights, alarm clocks, pocket calculators, picture frames, swizzle sticks, magnifying glasses, and side view mirrors.

4. The item of claim 1 further comprising an electronic circuit in electrical communication with said light emitting diode and said battery, said circuit allowing activation of said light emitting diode to occur for a preselected amount of time.

5. The item of claim 1 further comprising a light emitting diode activation switch.

6. The item of claim 1 further comprising a voltage step up circuit intermediate between said light emitting diode and said battery.

7. The promotional item of claim 1 wherein said ink is an invisible ink.

8. The promotional item of claim 1 wherein optical communication between said light emitting diode and said ink is through a transparent or translucent housing portion.

9. The promotional item of claim 1 wherein optical communication between said light emitting diode and said ink is through a transparent or translucent sheath.

10. The promotional item of claim 1 further comprising an integrated circuit intermediate between said light emitting diode and said battery, said integrated circuit controlling at least one function selected from the group consisting of: modifying battery voltage input to the light emitting diode, time limiting the circuit activation, and pulsing the emission from the light emitting diode.

11. A promotional item comprising:
a housing having a transparent or translucent portion;
an invisible ink forming indicia on said housing, said ink being discernable upon illumination by a wavelength greater than 365 nanometers and less than 420 nanometers;
a light emitting diode within said housing in optical communication with said ink and having an emission wavelength capable of stimulating visible light emission from said ink;
a battery; and
a switch that forms an electrical circuit between said light emitting diode and said battery.

12. The promotional item of claim 11 further comprising an integrated circuit intermediate between said light emitting diode and said battery, said integrated circuit controlling at least one function selected from the group consisting of: modifying battery voltage input to the light emitting diode, time limiting the circuit activation, and pulsing the emission from the light emitting diode.

13. The item of claim 11 further comprising an abrasion protective overlayer on said ink.

14. The item of claim 11 wherein said housing is selected from the group consisting of: pens, watches, key chains, flashlights, penlights, alarm clocks, pocket calculators, picture frames, swizzle sticks, magnifying glasses, and side view mirrors.

15. The item of claim 11 further comprising an electronic circuit in electrical communication with said light emitting diode and said battery, said circuit allowing activation of said light emitting diode to occur for a preselected amount of time.

16. The item of claim 11 further comprising a voltage step up circuit intermediate between said light emitting diode and said battery.

17. A process for producing a promotional item comprising the steps of:
integrating the light emitting diode circuit into a promotional item, the light emitting diode circuit emitting a wavelength of between 365 nanometers and 420 nanometers;
applying an ink to said promotional item, said ink fluorescing or phosphorescing visible light upon stimulation by wavelength of between 365 nanometers and 420 nanometers; and
transmitting emissions from the light emitting diode through said promotional item and onto said ink.

18. The process of claim 17, wherein said ink is an invisible ink.

19. The process of claim 17, wherein emission from said light emitting diode is limited to a preselected amount of time.
